(19) United States
(12) Patent Application Publication
(10) Pub. No.: US 2006/0143173 A1
(43) Pub. Date: Jun. 29, 2006

(54) Method, apparatus, and system for implementing vehicle identification

(75) Inventors: Jim Cancilla, San Jose, CA (US); Sunil Reddy, Corpus Christi, TX (US); Dale Trsar, Mount Prospect, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated

(21) Appl. No.: 11/025,359

(22) Filed: Dec. 29, 2004

Related U.S. Application Data
(63) Continuation-in-part of application No. 11/025,369, filed on Dec. 29, 2004.

(51) Int. Cl. G06F 7/00; G06F 17/30

(52) U.S. Cl. 707/6

(57) ABSTRACT

A method, apparatus, and system are provided for implementing vehicle identification. Characteristic data is obtained from at least one sensing device, the characteristic data being reflective of at least one characteristic of a vehicle. The characteristic data is compared to a pattern in a pattern-recognition database, the pattern being associated with identification data corresponding to a combination of vehicle characteristics. When the characteristic data substantially matches the pattern, the identification data is received. Responsive to receiving the identification data, an identifier is created based at least in part on the identification data. The created identifier reflects that the vehicle has the combination of vehicle characteristics.

### CROSS REFERENCE TO RELATED APPLICATION

The present application is a continuation-in-part of—and incorporates herein by reference in its entirety—U.S. patent application Ser. No. ______ (Attorney Reference No. 04-491), filed concurrently herewith, entitled “Method, Apparatus, and System for Accessing Multiple Vehicle-Information Databases Using a Handheld Vehicle Diagnostic Tool.”

### BACKGROUND

1. Technical Field

The claims and examples of embodiments relate to automated pattern recognition and, more particularly, to a method, apparatus, and system for implementing vehicle identification.

2. Description of Related Art

Manufacturers of vehicles such as cars, trucks, and buses produce many different models of vehicles. For example, the Ford Motor Company of Dearborn, Michigan manufactures the Explorer®, the Taurus®, the Focus®, and many others. And, almost as a matter of course, these manufacturers develop a new version of each model each year, which typically vary in some way from the previous versions. Due, at least in part, to varying physical dimensions, such as wheel base and space under the hood, each of the different models from different manufacturers inherently has varying attributes. For example, they may require different batteries, fuel pumps, headlights, etc. Also, due to their inherent differences, each of the models may require different procedures for replacing parts or for performing other types of maintenance.

Furthermore, for every model every year, manufacturers offer multiple options, such as engine type, transmission type, air conditioning, paint color, etc., each of which may have it's own attributes. Manufacturers typically select some number of attribute combinations, and then manufacture many sets of vehicles having the same or similar combinations of attributes. Consumers and retailers, such as dealerships, may then choose from pre-built vehicles with these combinations of attributes. Alternatively, the consumers and retailers may specify a combination of attributes from a list of the combinations of attributes to have vehicles built accordingly.

In any case, technicians performing vehicle repair and maintenance encounter vehicles in many shapes and sizes. More particularly, technicians service vehicles that have many different combinations of attributes, such as make (manufacturer), model, year, engine type, etc. As explained, however, this variance is not unlimited. Even though vehicles have many different combinations of attributes, there are sets of thousands of vehicles on the road that have the same or substantially the same combination of attributes, including those attributes that are relevant for a particular purpose, such as selecting a car battery or determining the proper procedure for replacing the battery. Other attributes, such as paint color, would be irrelevant to a majority of such particular inquiries.

Technicians need to be able to access repair and maintenance information specific to each of these combinations of vehicle attributes. In response to this need, information systems have been developed to organize this information into databases and large volumes of paper records. When a technician needs information that is specific to a vehicle's combination of attributes, the technician typically accesses one or more of such databases, and then specifies a sufficient number of the vehicle's attributes to obtain the required information. The technician may access this information from a local copy of a database; but more likely, the information is pulled from a remote database by using a personal computer connected to a network, or perhaps by using a handheld diagnostic tool that directly or indirectly accesses the remote database.

To do this, the technician typically uses software that requests that the technician specify, as an input, a number of the vehicle's attributes. Responsive to such an input, a database is accessed, and the desired information is obtained and then reported. This process of “identifying” or “ID-ing” a vehicle via manual entry of vehicle attributes takes time and effort.

Compounding the inefficiency of manually entering vehicle attributes, a technician may need to access more than one remote database while servicing a vehicle. Each time the technician wants to access a new database, the technician is typically required to “re-identify” or “re-ID” the same vehicle. To re-ID the same vehicle, the technician exits the current program or menu option, and then repeats the process of manually entering the vehicle attributes to access the next database. And this procedure is typically repeated for each new vehicle.

### SUMMARY

A method, apparatus, and system are provided for implementing vehicle identification. Characteristic data is obtained from at least one sensing device, the characteristic data being reflective of at least one characteristic of a vehicle. The characteristic data is compared to a pattern in a pattern-recognition database, the pattern being associated with identification data corresponding to a combination of vehicle characteristics. When the characteristic data substantially matches the pattern, the identification data is received. Responsive to receiving the identification data, an identifier is created based at least in part on the identification data, the created identifier reflecting that the vehicle has the combination of vehicle characteristics.

This as well as other aspects and advantages will become apparent to those of ordinary skill in the art by reading the following detailed description, with reference where appropriate to the accompanying drawings.

### BRIEF DESCRIPTION OF THE DRAWINGS

Various examples of embodiments are described herein with reference to the following drawings, wherein like numerals denote like entities.

FIG. 1 is a simplified block diagram of a communications system in which vehicle identification may be carried out;

FIG. 2 is a simplified block diagram of a computer that may be used for carrying out vehicle identification;

FIG. 3 is a simplified block diagram of sensing devices that may be used for carrying out vehicle identification; and

FIG. 4 is a flowchart illustrating a flow for carrying out vehicle identification in a communications system, such as the communication system of FIG. 1.

### DETAILED DESCRIPTION

1. Overview

A method, apparatus, and system are provided for implementing vehicle identification. Included in the apparatus and system are one or more sensing devices that are operable to obtain data reflective of one or more characteristics of a vehicle. The sensing devices may obtain such vehicle-characteristic data by scanning the vehicle at a particular location, e.g., at the point the vehicle is pulled into a service station bay. The sensing devices may be embodied as (i) weight sensors to measure the weight of the vehicle, (ii) cameras to capture images of all or part of the vehicle, (iii) an infrared or sonar system to collect a cross-section or three-dimensional model of the vehicle, (iv) receiving devices for capturing transmitted information, and/or (v) other devices.

Some or all of the sensing devices could be movable relative to the vehicle. For example, one or more of the cameras may be mounted on a movable boom, which is operable to move along an axis of the vehicle. Alternatively, the vehicle may be moved relative to one or more of the sensing devices. In addition, the vehicle may also move relative to one or more of the sensing devices under the vehicle's own power.

A computer adapted to receive the vehicle-characteristic data from the sensing device(s) may be used to obtain identification data that is indicative of a combination of vehicle attributes that the particular vehicle has. To do this, the computer may compare the vehicle-characteristic data with known data patterns stored in a pattern-recognition database, each pattern being associated with identification data corresponding to a combination of vehicle attributes.

When a match is found between the vehicle-characteristic data and one of the data patterns, the computer obtains the identification data associated with the matching pattern. As stated, this identification data corresponds to a particular combination of vehicle attributes. Based at least in part on this identification data, the computer then creates an identifier that reflects that the vehicle has the corresponding combination of vehicle attributes.

The created identifier may be used for any purpose in which a vehicle identifier is used. For example, the identifier may be used to access one or more vehicle-information databases during the servicing of the vehicle. As such, the technician may access these databases without the need to manually enter a set of vehicle attributes to “identify” the vehicle to the databases. Instead, the technician may indicate which of the vehicle-information databases (in other words, what type of vehicle information) they would like to access, and the computer may responsively send to a selected database a request that includes the created identifier.

Using that identifier as a key, the selected database may then return one or more data records to the computer, which the computer may display to aid the technician in servicing the vehicle. If the technician subsequently wants to access additional databases, they would not have to “re-identify” the vehicle. Instead, the created identifier may be stored in memory or other data storage for repeated use. Compared with manual vehicle identification, time is saved and accuracy is improved, as human data entry may be slower and more likely to include error.

The received vehicle-characteristic data may also be used as proof of the vehicle's condition at a point in time. For example, vehicle-characteristic data captured soon after a vehicle arrives at a service station could be used to refute a customer's claim that a dent or other damage befell the vehicle during the vehicle's time at the service station. As an example, if a set or subset of vehicle-characteristic data received upon the vehicle's arrival matched vehicle-characteristic data received after a customer lodges a complaint, this could refute the complaint. As such, any set of vehicle-characteristic data could be “stamped” with a time/date upon receipt.

2. Architectural Overview

a. Example Communications System

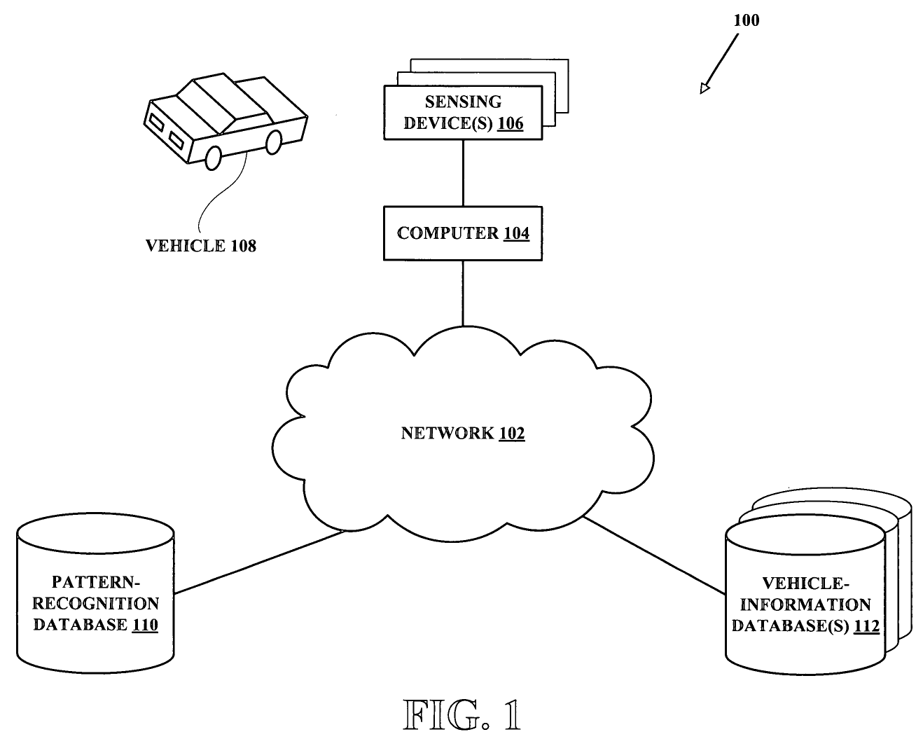

FIG. 1 is a simplified block diagram of a communications system in which vehicle identification may be carried out. It should be understood that this and other arrangements described herein are set forth only as examples. Those skilled in the art will appreciate that other arrangements and elements (e.g., machines, interfaces, functions, orders, and groupings of functions, etc.) can be used instead, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. Various functions may be carried out by a processor executing instructions stored in memory.

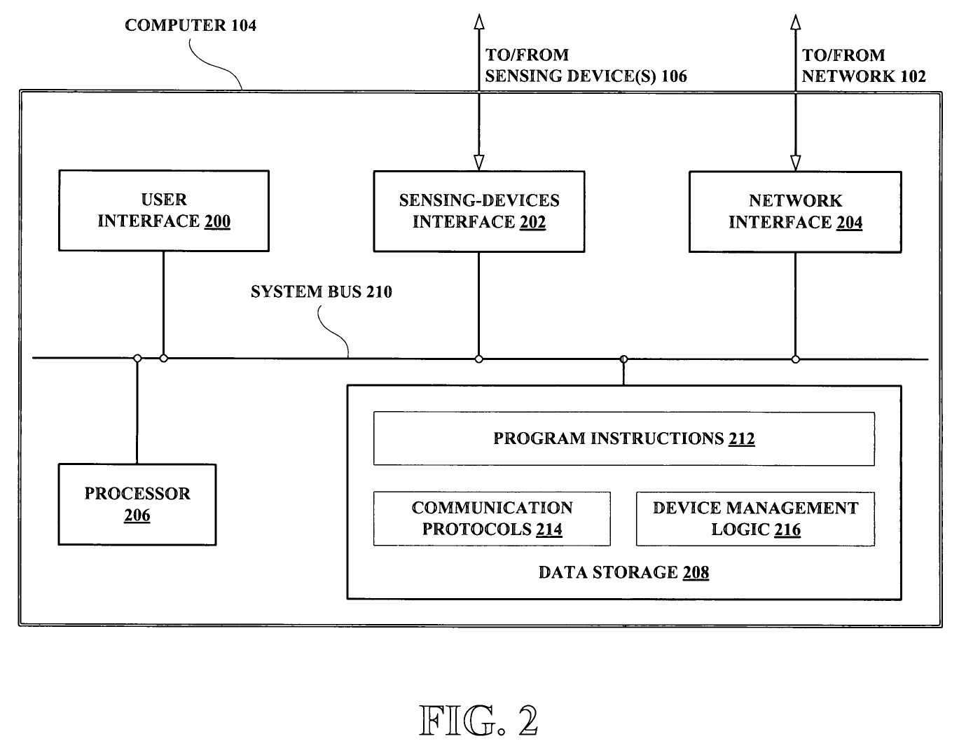

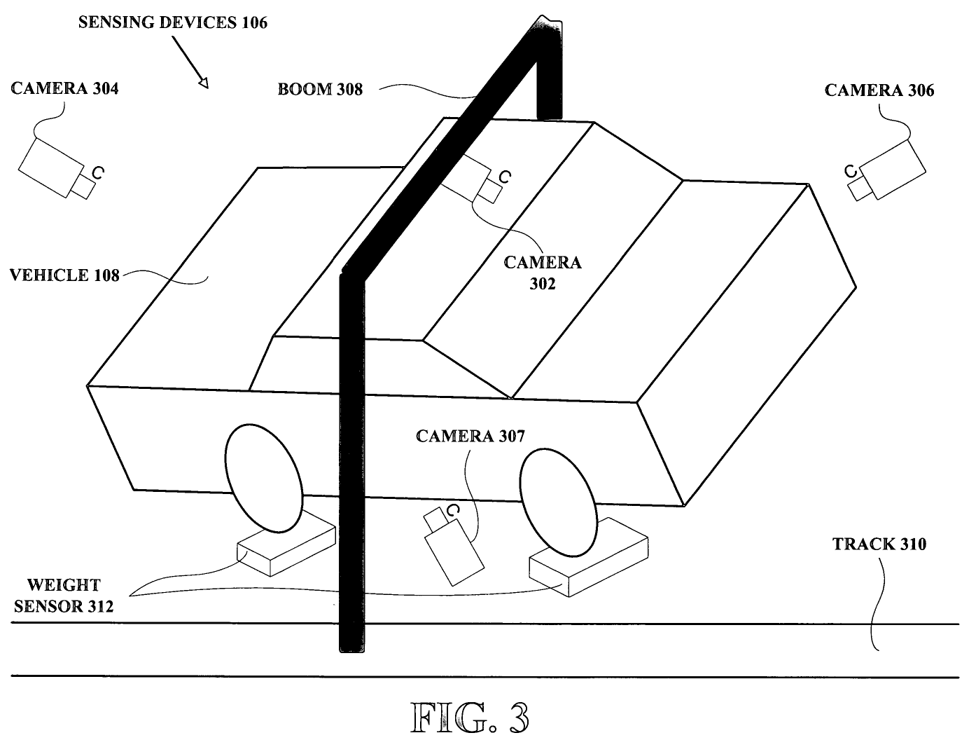

As shown in FIG. 1, the communications system 100 includes a network 102, a computer 104, one or more sensing devices 106 for obtaining data reflective of one or more characteristics of a vehicle 108, a pattern-recognition database 110, and one or more vehicle-information databases 112. The computer 104, the sensing device(s) 106, and the vehicle-information database(s) 112 are illustrative; there could be any number of computers and any number of vehicle-information databases in communication with the network 102, and any number of sensing devices in communication with the computer 104. The computer 104 and the sensing device(s) 106 are further explained in connection with FIGS. 2 and 3, respectively.

The network 102 may include one or more packet-switched networks, such as the Internet; one or more circuit-switched networks, such as the Public Switched Telephone Network; one or more wide area networks; one or more local area networks; one or more public networks; one or more private networks; one or more wired networks; and/or one or more wireless networks. Devices in communication with the network 102, such as the computer 104 and the databases 110-112, may transmit and receive data using a packet-switched protocol, such as the Internet Protocol (IP), and may be identified by an address such as an IP address. Other protocols and addressing schemes may be used as well.

The pattern-recognition database 110 may, for example, be stored in one or more network servers programmed to communicate over the network 102. Alternatively, the database 110 may be locally accessible to the computer 104; for example, the database 110 may be stored in one or more hard drives connected to the computer 104.

The pattern-recognition database 110 stores known data patterns for comparison with the data gathered by the sensing devices 106. The data patterns may be embodied as image data, weight data, data related to the physical dimensions of vehicles and/or vehicle parts, data related to particular components and/or the physical appearance of those components, etc. In general, the data patterns may be embodied as any type of data related to any observable, receivable, and/or measurable vehicle characteristic.

Like the pattern-recognition database 110, some or all of the vehicle-configuration databases 112 may be, for example, stored in one or more network servers programmed to communicate over the network 102. Alternatively or additionally, some or all of the databases 112 may be locally accessible to the computer 104; for example, some or all of the databases 112 may be stored in one or more hard drives connected to the computer 104.

Each of the vehicle-configuration databases 112 may have been designed to supply different information for servicing the vehicle 108, and thus, each of the vehicle-configuration databases 112 may store a different type of vehicle information. For example, one of the vehicle-configuration databases 112 may contain information relating to controllers and communication systems present on many modern vehicles, while another of the databases 112 may store information relating to exhaust systems, fuel systems, ignition systems, etc. Generally stated, each database 112 may store information relating to any aspect of vehicles.

b. Example Computer Architecture

FIG. 2 is a simplified block diagram of a computer that may be used for carrying out vehicle identification. In particular, FIG. 2 is a diagram of an embodiment of the computer 104 of FIG. 1. The computer 104 typically includes a user interface 200, a sensing-devices interface 202, a network interface 204, a processor 206, and a data storage 208, all of which may be linked by a communication (e.g., a system) bus 210. As examples, the computer 104 may be a laptop computer; a desktop computer; a personal digital assistant (PDA); a cellular telephone; a handheld diagnostic tool such as the MODIS™ Modular Diagnostic Information System (Elite 4.2), model no. EEMS300C02, manufactured by Snap-on Incorporated of Kenosha, Wis.; and/or any other computing device that is programmed to interface with the sensing devices 106 and the network 102, and to carry out the functions described herein.

The user interface 200 may include mechanisms to provide outputs to and receive inputs from users. For providing outputs, the user interface 200 may include a display (e.g., an LCD) for presenting text-based and/or graphics-based messages, menus, and prompts. The user interface 200 may also include a speaker for playing audio recordings and prompts, as well as various LEDs to indicate various conditions. In general, the user interface 200 may include any mechanisms now known or later developed for conveying information to users or other devices.

For receiving inputs, the user interface 200 may include one or more input mechanisms, such as a mouse, a keyboard, a light-pen, buttons, a touch-sensitive display, a microphone, a bar code scanner, an optical scanner, a receiver for infrared and/or radio signals, and any number of other input mechanisms. In general, the user interface 200 may include any mechanisms now known or later developed for receiving inputs from users or other devices.

The sensing-devices interface 202 provides the computer 104 with an interface to connect to the sensing devices 106, and may be embodied as an Ethernet adapter or as a Universal Serial Bus adapter, as examples. Alternatively or additionally, the computer 104 may be equipped to communicate wirelessly with some or all of the sensing devices 106. In that case, the sensing-devices interface 202 may include circuitry to enable the computer 104 to communicate locally with the sensing devices 106 using a wireless interface. This wireless interface may be a wireless local area network (WLAN) that uses a protocol such as IEEE (Institute of Electrical and Electronics Engineers) 802.11x or, perhaps, Bluetooth® technology.

The network interface 204 provides the computer 104 with an interface to connect to the network 102, and may include, for example, an Ethernet adapter. Alternatively or additionally, the computer 104 may be equipped to communicate wirelessly with the network 102, in which case the network interface 204 may include a wireless-communication chipset and antenna for carrying out such communications.

The network interface 204 may also include circuitry to enable the computer 104 to communicate locally with other devices over a physical connection, such as an Ethernet cable, or over a wireless connection, such as a wireless LAN that uses a protocol such as IEEE 802.11× or Bluetooth® technology. The other devices, which may be embodied as routers and/or modems, may then communicate with other entities on the network 102, such as the databases 110-112.

In some embodiments, the sensing-devices interface 202 and the network interface 204 may be integrally formed or be one in the same interface. For example, a wireless PCMCIA card or wireless modem, which places the computer 104 on a wireless LAN, may serve the functions of both the sensing-devices interface 202 and the network interface 204.

The processor 206 may control many of the operations of the computer 104 by executing a set of instructions 212 stored in the data storage 208, and may comprise multiple (e.g., parallel) processors, such as a general purpose microprocessor and/or a discrete digital signal processor.

The data storage 208 may store the program instructions 212, a set of communication protocols 214, and a set of device management logic 216. The data storage 208 may take various forms, in one or more parts, such as a non-volatile storage block and/or a removable storage medium. The program instructions 212 may comprise program instructions executable by the processor 206 to carry out various functions described herein, including the functions described in the “Example Operation” section, below.

The communication protocols 214 may be necessary to receive data from and send data to the sensing devices 106, and to receive and send data over the network 102, and may include the Session Initiation Protocol (SIP), HyperText Transfer Protocol (HTTP), Transmission Control Protocol (TCP), User Datagram Protocol (UDP), Internet Protocol (IP), Simple Mail Transfer Protocol (SMTP), Dynamic Host Configuration Protocol (DHCP), Domain Name Service (DNS), Internet Control Message Protocol (IMCP), Point-to-Point Protocol (PPP), IEEE 802.11x, Bluetooth®, cdma2000®, one or more proprietary protocols, as well as any other communication protocols. Compatible protocols may be stored in the sensing devices 106, in the databases 110-112, and in other entities on the network 102. The device management logic 216 may be used to handle aspects of the computer 104 such as memory and file management.

c. Example Sensing Devices

FIG. 3 is a simplified block diagram of sensing devices that may be used for carrying out vehicle identification. In particular, FIG. 3 is a diagram of an embodiment of the sensing devices 106 of FIG. 1. As shown in FIG. 3, the sensing devices 106 comprise cameras 302, 304, 306, and 307. The camera 302 is mounted to a boom 308 that is movable along a track 310. Cameras 304-306, however, may be mounted to a stationary beam (not shown). The camera 307 is positioned beneath the vehicle 108, such that the camera 307 may capture image or video data of the underside of the vehicle 108. Camera 307 may be accompanied by lights to illuminate the undersurface of the vehicle 108, and may be stationary or movable relative to the vehicle 108.

The cameras 302-307 may include one or more still-image cameras, one or more video cameras, one or more film cameras, one or more digital cameras, and any other types of cameras. Some or all of the cameras 302-307 may be utilized to capture images or video of all or part of the vehicle 108. Alternatively or additionally, some or all of cameras 302-307 may be used to capture images or video of specific components of vehicle 108. And the cameras 302-307 are illustrative; any number of cameras could be used to capture images or video of the vehicle 108.

The sensing devices 106 may also include weight sensors 312 for measuring the weight of the vehicle 108 and/or other devices (not shown) for perceiving other characteristics of the vehicle. For example, the sensing devices 106 may include a light curtain, one or more sonar devices, and/or one or more infrared devices, any or all of which could be used to obtain data reflective of (i.e., appreciate) a cross-section or three-dimensional model of the vehicle 108, in the manner generally known in the art of pattern recognition and digital imaging.

Furthermore, the sensing devices 106 may include a device operable to receive radio signals if, for example, the vehicle 108 were outfitted with a device to transmit one or more identifiers or identifying characteristics to the sensing devices 106 via a radio signal. The sensing devices may include one or more devices to capture onboard diagnostic information, such as what is known as OBD3 information, transmitted from the vehicle 108. In general, the sensing devices 106 may include any devices now known or later developed for obtaining data reflective of one or more characteristics of the vehicle 108.

The sensing devices 106 may include one or more devices that are movable relative to the vehicle 108. For example, the combination of the boom 308 and the track 310 enables the camera 302 to be moved along the longitudinal axis of the vehicle 108. The camera 302 may thus be able to capture images and/or video of multiple areas of the vehicle 108. Furthermore, the camera 302 may be able to capture images and/or video of these multiple areas from different angles. Detailed vehicle-characteristic data may thus be obtained by the sensing devices 106.

Other of the sensing devices 106 could also be mounted to the boom 308, or to any other apparatus arranged to move in any orientation relative to or along any axis or contour of the vehicle 108. As examples, one or more sonar or infrared sensors may be mounted to the boom 308, and may gather data about the vehicle 108 as the boom 308 moves along the track 310. And one or more sensing devices, such as the camera 307 and any other sensing devices, may be mounted to a separate track (not shown) beneath the vehicle, such that those sensing devices may obtain information about the vehicle 108 from beneath the vehicle.

Alternatively or additionally, the sensing devices 106 may include mechanics operable to move the vehicle 108 relative to one or more of the sensing devices 106. For example, the vehicle 108 may be positioned—perhaps in the “Park” gear—with its wheels in or on an apparatus that would move the vehicle 108 from one position to another, such as from outside to inside a service bay (similar to the way vehicles are moved through an automatic carwash). The vehicle 108 may also be driven through or past one or more of the sensing devices 106 under the vehicle's own power. In any case, during this movement, one or more of the sensing devices 106 may obtain data reflective of one or more of the characteristics of the vehicle 108.

3. Example Operation

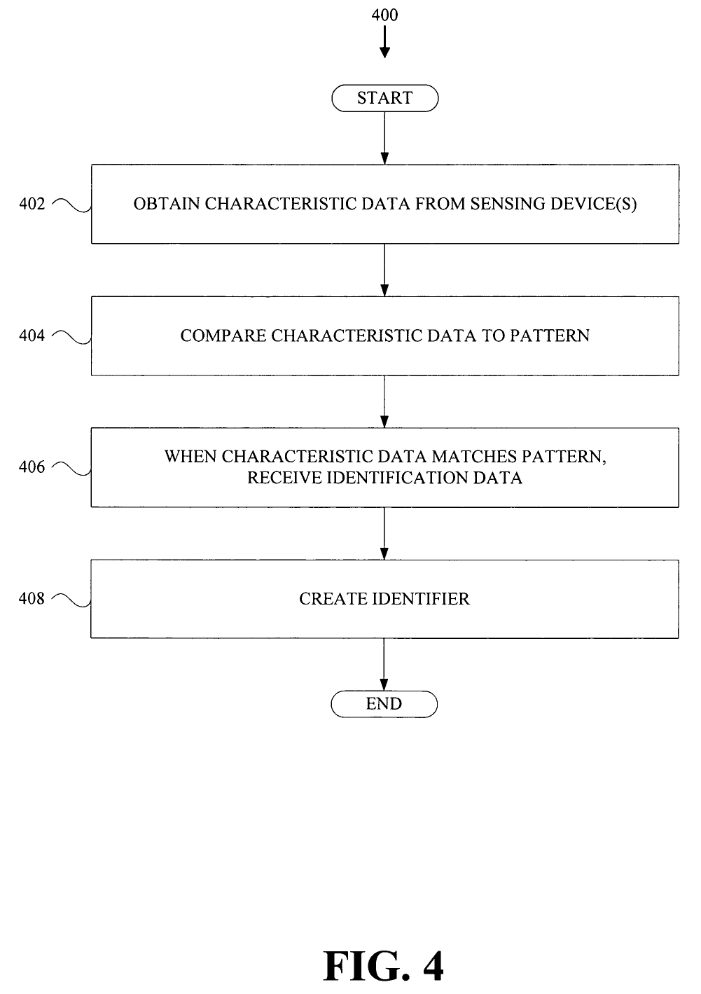

FIG. 4 is a flowchart illustrating a flow for carrying out vehicle identification in a communications system, such as the communication system of FIG. 1. As shown in FIG. 4, the flow 400 begins, at step 402, with the computer 104 executing one or more of the program instructions 212 to obtain characteristic data from the sensing devices 106. As described above, the characteristic data obtained from the sensing devices 106 is reflective of one or more characteristics of the vehicle 108. The characteristic data may be image data, video data, weight data, or any other type of data.

Step 402 may involve the computer 104 executing one or more of the program instructions 212 to send a command to one or more of the sensing devices 106 to cause the sensing devices 106 to take measurements and transmit data reflecting those measurements to the computer 104. This may occur in response to a repair technician entering a command into the computer 104. Alternatively, the sensing devices 106 may include an automated trigger, which causes the sensing devices 106 to take and report measurements in response to a triggering event, such as the vehicle 108 being pulled into a service bay.

As described with respect to FIG. 3, before, between, and/or during the step of obtaining the characteristic data from the sensing devices 106, the computer 104 may execute one or more of the program instructions 212 to move one or more of the sensing devices 106 relative to the vehicle 108. For example, the computer 104 may move the camera 302 relative to the vehicle 108 by moving the boom 308 along the track 310. Alternatively or additionally, the computer 104 may execute one or more program instructions 212 to move the vehicle 108 relative to one or more of the sensing devices 106. In addition, certain parts of the vehicle 108, such as the hood, may be opened such that the sensing devices 106 may gather data about additional aspects of the vehicle 108.

At step 404, the computer 104 executes one or more program instructions 212 to compare the characteristic data gathered at step 402 with one or more known data patterns stored in the pattern-recognition database 110. As explained above, the database 110 may be accessed by the computer 104 locally or over the network 102. In this example, the computer 104 executes one or more program instructions 212 to transmit a request message over the network 102 to a database management system (DMS) having access to the pattern-recognition database 110. This request message may comply with a communication protocol, such as SIP, HTTP, any of the other protocols listed above, or any other protocol. The request message typically includes the characteristic data gathered at step 402, or a representation of that data.

Upon receipt of the request message, the DMS having access to the pattern-recognition database 110 searches for a data pattern that substantially matches the characteristic data included in the request message. Each such pattern is associated with a set of identification data corresponding to a particular set of vehicle attributes. Each set of identification data may be stored in the database 110 as part of a data structure that also includes the corresponding data pattern. Or, the data structures in the database 110 may include, in addition to a particular data pattern, a pointer to a memory location in another database where the corresponding identification data may be found.

In any event, when a data pattern is found that substantially matches the characteristic data included in the request message, at step 406, the computer 104 executes one or more program instructions 212 to receive the set of identification data. In this example, the DMS 110 locates in the pattern-recognition database 110 the identification data associated with that particular pattern, and sends a response message including that identification data over the network 102 to the computer 104. As stated, that identification data corresponds to a particular combination of vehicle characteristics.

As an example, the identification data may be a multiple-field data structure, where each field contains a value indicative of a particular vehicle characteristic. The DMS may transmit this response message to the computer 104 using the same protocol as that used for the request message, or another communication protocol. Note that, in this example, the identification data is received by the computer 104 from the pattern-recognition database 110. Specifically, the identification data is received from the DMS having access to the database 110. But the computer 104 could just as well receive the identification data from another database.

At step 408, responsive to receiving the identification data, the computer 104 executes one or more program instructions 212 to create an identifier based at least in part on the identification data received at step 406. The created identifier reflects that the vehicle 108 has the combination of vehicle characteristics corresponding to the identification data received at step 406. By implication, the created identifier reflects that the vehicle 108 has a combination of vehicle characteristics represented by the matching pattern identified in the database 110. Thus, the present system has converted the characteristic data obtained from the sensing devices 106 into the created identifier, which may then be stored in the data storage 208 of the computer 104.

The computer 104 may create the identifier in step 408 in many ways. As one example, the computer 104 may parse the identification data received at step 406, and convert the values stored in each field of that identification data into numerical codes. The computer 104 may then construct the identifier by stringing together the numerical codes according to a predetermined protocol or algorithm. The created identifier could thus be, for example, a 32-bit number in which different groups of the bits 0-31 represent different vehicle characteristics. The created identifier thereby reflects that the vehicle 108 has the combination of vehicle characteristics corresponding to the received identification data.

As another example, the computer 104 may create the identifier using a table stored in the data storage 208 or maintained on a network server (not shown). This table may enable the computer 104 to translate between a given set of identification data and a corresponding identifier. If the table is maintained on a network server, the computer 104 may transmit to the network server a request message that includes the identification data received at step 406. The computer may in turn receive a response that includes the identifier, which the computer 104 may then store for further use.

The computer 104 may use the created identifier for several purposes. For one, the computer 104 may execute one or more program instructions 212 to display data (on the user interface 200) related to the combination of vehicle characteristics reflected by the created identifier, which is a combination of vehicle characteristics that the vehicle 108 has been determined to have.

As another possibility, either automatically or in response to a technician entering a command, the computer 104 may execute one or more program instructions 212 to use the created identifier to access one or more vehicle-information databases 112. The computer 104 may execute one or more program instructions 212 to transmit a request message to a selected one of the vehicle-information databases 112. The request message may include the created identifier, which the selected database 112 may then use as a key to the respective database. The selected database 112 may use the created identifier as a key by searching for one or more data records having a value equal to the created identifier stored in a particular field. The selected database 112 may thereby identify those data records as being responsive to the request message.

The selected vehicle-information database 112 (or a DMS having access to the database 112) may then transmit a response message to the computer 104 over the network 102 (using a suitable communication protocol). This response message may contain one or more data records from the selected vehicle-information database 112 that are associated with the created identifier, which in turn, corresponds to the combination of vehicle attributes. As a necessary part of accessing these records, each of the vehicle-information databases 112 may be configured or adapted to accept an input in the format of the created identifier as a key.

Upon receiving the response message containing the data records, the computer 104 may responsively execute one or more program instructions 212 to order a diagnostic test to be performed on the vehicle 108. The computer 104 may order the test by using information contained in the received data records to access a stored table of possible tests. After identifying a recommended test, the computer 104 may simply display a message to the technician via the user interface 200, to recommend that the particular diagnostic test be performed.

Alternatively, the computer 104 may order the diagnostic test in a more automated sense, by instructing one or more testing mechanisms (such as vehicle-information sensors) to gather data from the vehicle 108. To accomplish this, the computer 104 may be arranged to communicate with one or more testing mechanisms in a manner similar to the way in which the computer 104 communicates with the sensing devices 106. Instead of or in addition to ordering one or more tests, the computer 104 may execute one or more program instructions 212 to present the received data records to the technician. The technician may then take additional steps if warranted in their professional judgment.

If the technician then wishes to again access the same vehicle-information database 112, or to access a second or third one of the databases 112, the technician may enter corresponding commands into the computer 104 via the user interface 200. Because the created identifier has been stored in the data storage 208 (or in another memory or data-storage module) in the computer 104, the created identifier may be repeatedly used for accessing any number of vehicle-information databases 112 any number of times. Additionally, the computer 104 could execute one or more program instructions 212 to store the created identifier with an account maintained for the vehicle 108, and then use the created identifier for future appointments involving the same vehicle 108, as either a time-saving or double-checking step or to ensure that the vehicle 108 had been properly identified.

Thus, the technician need not “re-identify” the vehicle 108 prior to accessing additional vehicle-configuration databases 112. That is, the technician need not exit out of an application, or return to a higher-level menu option, and then respond to questions or fill in blanks related to the attributes that each vehicle-information database 112 requires for locating records.

The characteristic data obtained in step 402 may also prove useful in verifying proof of the condition of the vehicle 108 at a certain point in time. For example, the characteristic data obtained at step 402 could be stored in the computer 104. Then, after the vehicle 108 has been at the service station for some amount of time, be it hours, days, or weeks, a situation may arise in which a customer, likely the owner of the vehicle 108, claims that certain damage then appearing on the vehicle 108 was not there when the vehicle 108 was brought to the service station.

At that point, the characteristic data obtained at step 402 could be referenced. For example, a technician and the customer could look at a picture of the part of the vehicle 108 that is the focus of this discussion. As another alternative, a second set of characteristic data could then be obtained from the at least one sensing device. This second set of characteristic data would be reflective of the some or all of the characteristics of the vehicle 108 represented by the first set of characteristic data. The computer 104 could then compare the two sets of characteristic data, and determine whether the values matched, or whether there was a difference between the two data sets that could support the customer's claim.

4. Conclusion

In view of the wide variety of embodiments that can be applied, it should be understood that the illustrated embodiments are examples only, and should not be taken as limiting the scope of the following claims. In the embodiments described herein, on-board vehicle systems and other vehicle-mounted devices may include or be utilized with any appropriate voltage source, such as a battery, an alternator and the like, providing any appropriate voltage, such as about 12 Volts, about 24 Volts, about 42 Volts, and the like.

Further, the embodiments described herein may be used with any desired system or engine. Those systems or engines may comprise items utilizing fossil fuels such as gasoline, natural gas, propane and the like, electricity, such as that generated by battery, magneto, solar cell and the like, wind and hybrids or combinations thereof. Those systems or engines may be incorporated into another system, such as an automobile, a truck, a boat or ship, a motorcycle, a generator, an airplane and the like.

The embodiments described above include computing systems, controllers, and other devices that contain processors. These devices may contain at least one Central Processing Unit (“CPU”) and a memory. In accordance with the practices of persons skilled in the art of computer programming, reference to acts and symbolic representations of operations or instructions may be performed by the various CPUs and memories. Such acts and operations or instructions may be referred to as being “executed,” “computer executed,” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs, and that other platforms and CPUs may support the described methods.

The data bits may also be maintained on computer-readable media including magnetic disks, optical disks, and any other volatile (e.g., Random Access Memory (“RAM”)) or non-volatile (e.g., Read-Only Memory (“ROM”)) mass storage system readable by the CPU. The computer readable media may include cooperating or interconnected computer-readable media, which exist exclusively on the processing system, or that are distributed among multiple, interconnected processing systems that may be local or remote to the processing system.

1. A method for implementing vehicle identification, the method comprising:
obtaining characteristic data from at least one sensing device, the characteristic data being reflective of at least one characteristic of a vehicle;
comparing the characteristic data to a pattern in a pattern-recognition database, the pattern being associated with identification data corresponding to a combination of vehicle characteristics;
when the characteristic data substantially matches the pattern, receiving the identification data; and
responsive to receiving the identification data, creating an identifier based at least in part on the identification data, the created identifier reflecting that the vehicle has the combination of vehicle characteristics.

2. The method of claim 1, wherein the at least one sensing device comprises at least one device selected from the group consisting of a camera, a light curtain, a sonar device, an infrared device, a radio device, and a weight sensor.

3. The method of claim 1, wherein the at least one characteristic of the vehicle comprises at least one characteristic selected from the group consisting of a physical dimension, a weight, and a vehicle component.

4. The method of claim 1, further comprising moving at least one of the at least one sensing device relative to the vehicle.

5. The method of claim 1, further comprising moving the vehicle relative to at least one of the at least one sensing device.

6. The method of claim 1, wherein at least one of the at least one sensing device is mounted to a boom that is movable relative to the vehicle, the method further comprising moving the boom relative to the vehicle.

7. The method of claim 1, further comprising ordering at least one diagnostic test on the vehicle.

8. The method of claim 1, further comprising storing the created identifier with an account maintained for the vehicle.

9. The method of claim 1, further comprising:
using the created identifier to access a first vehicle-information database;
receiving at least one data record from the first vehicle-information database, the at least one data record corresponding to the combination of vehicle characteristics; and
presenting the at least one data record to a user.

10. The method of claim 1, further comprising:
storing the obtained characteristic data as a first set of characteristic data;
obtaining a second set of characteristic data from the at least one sensing device, the second set of characteristic data being reflective of the at least one characteristic of the vehicle; and
comparing the first set of characteristic data to the second set of characteristic data, in order to compare the condition of the vehicle at the time the first set of characteristic data was obtained to the condition of the vehicle at the time the second set of characteristic data was obtained.

11. An apparatus for implementing vehicle identification, the apparatus comprising:
at least one sensing device;
a processor; and
a data storage comprising program instructions executable by the processor to:
obtain characteristic data from the at least one sensing device, the characteristic data being reflective of at least one characteristic of a vehicle;
compare the characteristic data to a pattern in a pattern-recognition database, the pattern being associated with identification data corresponding to a combination of vehicle characteristics;
receive the identification data when the characteristic data substantially matches the pattern; and
create, in response to receiving the identification data, an identifier based at least in part on the identification data, the created identifier reflecting that the vehicle has the combination of vehicle characteristics.

12. The apparatus of claim 11, wherein the at least one sensing device comprises at least one device selected from the group consisting of a camera, a light curtain, a sonar device, an infrared device, a radio device, and a weight sensor.

13. The apparatus of claim 11, wherein the at least one characteristic of the vehicle comprises at least one characteristic selected from the group consisting of a physical dimension, a weight, and a vehicle component.

14. The apparatus of claim 11, wherein the data storage further comprises program instructions executable by the processor to move at least one of the at least one sensing device relative to the vehicle.

15. The apparatus of claim 11, wherein the data storage further comprises program instructions executable by the processor to move the vehicle relative to at least one of the at least one sensing device.

16. The apparatus of claim 11, wherein the data storage further comprises program instructions executable by the processor to:
use the created identifier to access a first vehicle-information database;
receive at least one data record from the first vehicle-information database, the at least one data record corresponding to the combination of vehicle characteristics; and
present the at least one data record to a user.

17. The apparatus of claim 16, further comprising a network interface, wherein the data storage further comprises program instructions executable by the processor to access at least one of the pattern-recognition database and the first vehicle-information database over a network via the network interface.

18. The apparatus of claim 11, wherein the data storage further comprises program instructions executable by the processor to:
store the obtained characteristic data as a first set of characteristic data;
obtain a second set of characteristic data from the at least one sensing device, the second set of characteristic data being reflective of the at least one characteristic of the vehicle; and
compare the first set of characteristic data to the second set of characteristic data, in order to compare the condition of the vehicle at the time the first set of characteristic data was obtained to the condition of the vehicle at the time the second set of characteristic data was obtained.

19. A system for implementing vehicle identification, the system comprising:
a network;
a pattern-recognition database server programmed to communicate over the network, the pattern-recognition database server having access to a pattern-recognition database;
at least one sensing device; and
a computer programmed to communicate (i) with the at least one sensing device via a sensing-devices interface and (ii) over the network via a network interface, the computer comprising a processor and a data storage comprising program instructions executable by the processor to:
obtain characteristic data from the at least one sensing device via the sensing-devices interface, the characteristic data being reflective of at least one characteristic of a vehicle;
transmit a first message over the network via the network interface to the pattern-recognition database server, the first message including the characteristic data, the first message requesting comparison of the characteristic data to at least one pattern in the pattern-recognition database, each pattern being associated with identification data corresponding to a respective combination of vehicle characteristics;
receive a second message over the network via the network interface when the characteristic data substantially matches a particular pattern, the second message including the identification data associated with the particular pattern; and
create, in response to receiving the second message, an identifier based at least in part on the included identification data, the created identifier reflecting that the vehicle has the corresponding combination of vehicle characteristics.

20. The system of claim 19, further comprising a first vehicle-information database server programmed to communicate over the network, the first vehicle-information database server having access to a first vehicle-information database, wherein the data storage further comprises program instructions executable by the processor to:
transmit a third message over the network via the network interface to the first vehicle-information database server, the third message including at least the created identifier, the third message requesting at least one data record from the first vehicle-information database based at least in part on the created identifier; and
receive a fourth message over the network via the network interface from the first vehicle-information database server, the fourth message including the at least one data record requested by the third message, the at least one data record corresponding to the combination of vehicle characteristics.
